(19) United States
(12) Patent Application Publication
(10) Pub. No.: US 2009/0309734 A1
(43) Pub. Date: Dec. 17, 2009

(54) INTELLIGENT SYSTEM AND METHOD TO MONITOR OBJECT MOVEMENT

(75) Inventors: Meruva Jayaprakash, Bangalore (IN); Nagasree Poluri, Gurgaon (IN); Prakash Srirama, Gurgaon (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown, NJ (US)

(21) Appl. No.: 12/482,363

(22) Filed: Jun. 10, 2009

(30) Foreign Application Priority Data
Jun. 16, 2008 (IN) 1433/DEL/2008

(51) Int. Cl. G08B 13/14

(52) U.S. Cl. 340/572.1

(57) ABSTRACT

A network including a processor and a plurality of signposts and readers are configured to implement a set of rules to monitor movement and location of a tagged asset. A rule can be represented by a hash table and can relate to tag movement, a facility attribute, or an asset protection policy.

### CROSS REFERENCE TO RELATED APPLICATIONS

This application claims priority to India Patent Application No. 1433/DEL/2008, filed Jun. 16, 2008, which is incorporated herein by reference.

### BACKGROUND

Existing asset tracking systems typically include a radio frequency identification (RFID) tag system or an ultra-wide band (UWB) radio frequency identification system. A long range system can be, for example, 100 meters. In a tracking system, a device affixed to the asset provides identification information. An asset can include an article of clothing, a medical device, a vehicle, or other high value object. The tag can be described as either passive (battery-less) or active (battery powered). Typically, an active tag is used for a long range application and a passive tag is used for a short range application.

Existing tag systems are prone to errors. One type of error concerns multiple detections of the same tag. As another example, an existing system may erroneously conclude that a tagged vehicle has exited a parking lot when in fact, the vehicle merely approached a reader near the exit without actually having departed.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a schematic of a system according to an example embodiment.

FIG. 2 illustrates a block diagram of a system according to an example embodiment.

FIG. 3A illustrates a schematic of a facility according to an example embodiment.

FIG. 3B illustrates a model of rules for the facility of FIG. 3A according to an example embodiment.

FIGS. 3C and 3D illustrate tabulated rules for the facility of FIG. 3A according to an example embodiment.

FIG. 4 illustrates a flow chart for a method according to an example embodiment.

FIG. 5 illustrates a flow chart for a method according to an example embodiment.

### DETAILED DESCRIPTION

In this document the term tag can refers to an active device that both transmits a radio frequency signal and receives a radio frequency signal. A tag can include an RFID device or a UWB device.

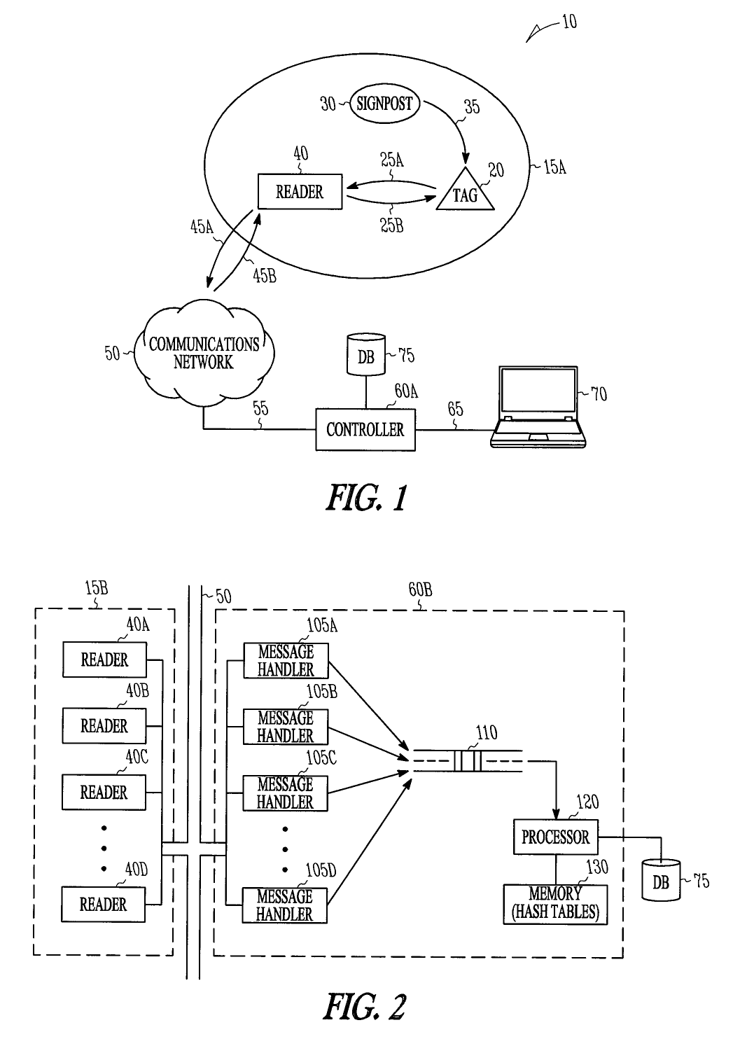

FIG. 1 illustrates a schematic of system 10 according to one example. System 10 includes frame of reference 15A, communication network 50, and controller 60A.

Frame of reference 15A refers to the environment in which tag 20 can move about. In the figure, tag 20 is shown within the boundary of frame of reference 15A; however, tag 20 can also travel beyond any such boundaries. Frame of reference 15A can include a building, a real estate site, a vessel, or any other physical space. Frame of reference 15A can be a two dimensional region or a three dimensional space. Frame of reference 15A may include an arbitrary region throughout which mobile tag 20 can travel.

Tag 20 includes an active device which can be interrogated with a radio frequency signal. Tag 20 can be affixed to an asset such as a person, an object (such as a medical device or medical equipment), a vehicle, or other physical object. Tag 20, along with any attached asset, can be repositioned relative to frame of reference 15A.

Signpost 30 includes a radio frequency signal transmitter having a fixed location relative to frame of reference 15A. In the figure, signpost 30 is shown within a boundary of frame of reference 15A; however, signpost 30 can also be located external to any such boundary. Signpost 30 transmits an identification code, or identifier, as denoted by arrow 35. In one example, at least one signpost 30 is deployed at a designated location within a building. Each signpost 30 serves as a location identifier.

Reader 40 includes a radio frequency signal transceiver having a fixed location relative to frame of reference 15A. As with signpost 30, reader 40 can be located internally or externally relative to frame of reference 15A. The location of reader 40 is selected to provide good RF coverage of the frame of reference in order to reliably receive data from tag 20.

In addition to bidirectional communication with tag 20 (as denoted by arrow 25A and arrow 25B), reader 40 also communicates bi-directionally with communication network 50, as denoted by arrow 45A and arrow 45B. Communication network 50 can be a wired or wireless system for communicating with controller 60A via link 55. Communication network 50 can convey digital data or analog data.

Controller 60A includes a processor or other circuitry for managing information concerning tag 20, signpost 30, reader 40, and frame of reference 15A. In the example shown, controller 60A is also coupled to database 75 and computer 70. Controller 60A, which can include a server, receives data from reader 40, executes rules and policies configured for execution and generates various signals to denote various conditions or events. Some examples of conditions or events include detection of presence at a location (AT), detection of entry or exit, or detection of a condition warranting an alarm (such as a zone violation).

Database 75 provides storage for data, instructions, rules, programming or other information concerning system 10. Computer 70 includes a display and a keyboard to enable human interaction with system 10. Computer 70 can also include a printer, a speaker, a light, a memory, a network connection (wide area or local area) or other input/output device. Computer 70 is coupled to controller 60A by link 65 which can include a wired or wireless connection.

Signpost 30 broadcasts a unique signpost identification code within a particular zone of frame of reference 15A. In one example, signpost 30 broadcasts a code corresponding to a condition of signpost 30. The condition (or health) can relate to a battery level, a self-diagnostic performance result, or other information. Tag 20 has a unique tag identification code and when tag 20 is located within that particular zone, tag 20 receives the unique signpost identification code and transmits both the signpost identification code and its own unique tag identification code. In various examples, tag 20 transmits a health code for signpost 30 or a health code for tag 20. The health code may denote a battery condition. In one example, tag 20 transmits a tag identification code, a tag health code, a signpost identification code, and a signpost health code.

Reader 40 receives the tag identification code and the signpost identification code from tag 20 as denoted by arrow 25A. Upon successful receipt, reader 40 sends an acknowledgment as denoted by arrow 25B. If the communication link between reader 40 and controller 60A is inoperable, reader 40 stores the data, along with a timestamp, and later attempts to forward the data. Upon receiving the message (or packet) from reader 40, controller 60A validates the message and processes the contents.

FIG. 2 illustrates a block diagram of selected portions of a system. The figure includes frame of reference 15B, network 50, and controller 60B.

Frame of reference 15B includes reader 40A, reader 40B, reader 40C, and reader 40D with ellipses to denote that any number of such readers is contemplated. Each of readers 40A, 40B, 40C, and 40D is coupled by a communication link with communication network 50. Any portion of the communication link can be wired or wireless.

Controller 60B includes message handler 105A, message handler 105B, message handler 105C, and message handler 105D with ellipses to denote that any number of message handlers is contemplated. Each particular message handler is configured to communicate with a particular reader, such as message handler 105A and reader 40A. In one example, a message handler and reader communicate using transmission control protocol/internet protocol (TCP/IP) and each message handler opens a connection to a corresponding reader using TCP/IP. Upon receiving a message from reader 40A, controller 60B (also in communication with communication network 50) validates to determine whether the message is received correctly or not. If the message is error free, then message handler 105A, for example, generates a job which is inserted into job queue 110 for further processing. A message can denote that tag 20 is in a particular zone (TagID, ZoneID), the health status of a tag, the health status of a reader, or other such job.

Processor 120 reads a job from job queue 110 and performs additional processing, including for example, evaluating a hash table, and storing results in database 75 or memory 130. In the figure, memory 130 also provides storage for hash tables.

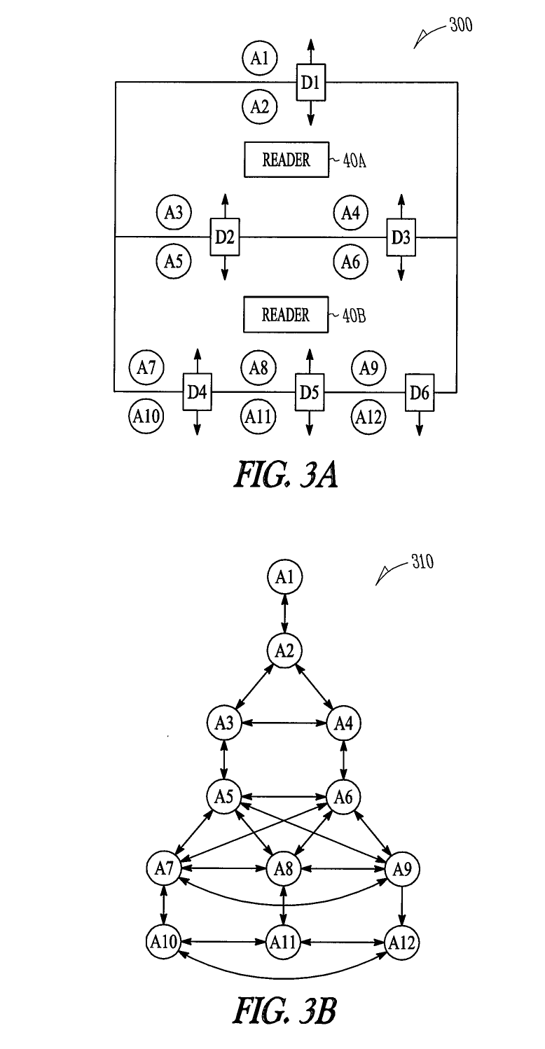

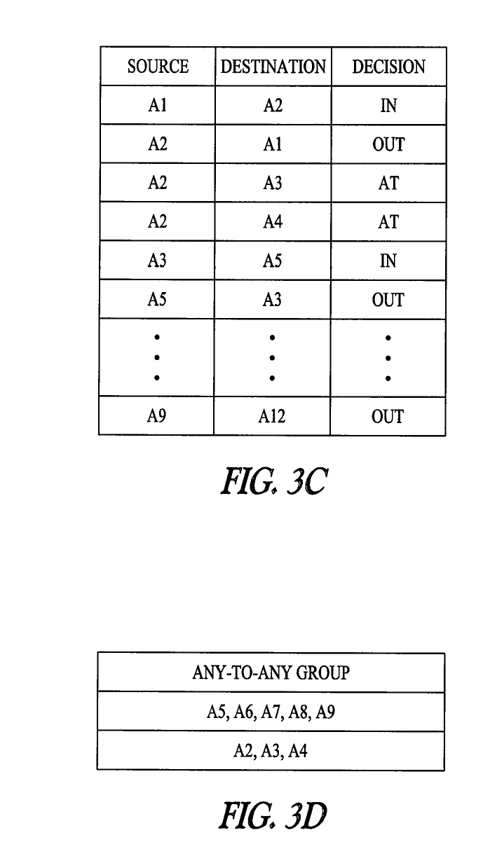

FIG. 3A illustrates a schematic of a floor plan for an example facility 300. Facility 300 includes twelve signposts (denoted signpost Al through signpost A12), each of which is located on either side of six doors (denoted door D1 through door D6). In addition, reader 40A covers the range associated with signposts A1, A2, A3, and A4, and reader 40B covers the range associated with signposts A5, A6, A7, A8, A9, A10, A11, and A12. In this example, the readers and signposts are not in direct communication with each other. Each of doors D1, D2, D3, D4, and D5 is bi-directional while door D6 allows exit only but not entry of a tagged object, as illustrated by the directional arrows with each door. No direct movement is allowed between signposts A1, A10, A11, and A12.

The various doors of facility 300 represent but one example of a structure that may impose a limit on asset movement at a particular frame of reference. Other examples of structures include a waterway (may restrict foot traffic about a geographical region), a stairway (may restrict wheeled vehicle traffic), and overhead clearance.

In this document, a particular reader (such as reader 40A or reader 40B) can be denoted by Rx, a particular tag (such as tag 20) can be denoted as Tx, and a particular zone can be denoted as Zx, where x is a numeric value.

This example can be viewed as representative of a divided manufacturing facility with this number of doors, one of which precludes re-entry upon exit. It will be understood that various configurations of doors, zones, signposts, and other elements are also contemplated.

The rules associated with the floor plan for facility 300 can also be represented by model 310 shown in FIG. 3B. Model 310 indicates that signpost A9 carries a single ended arrow while signpost A1 through signpost A8 and signpost A10 through signpost A12 carry double ended arrows.

FIG. 3C illustrates Table SD2 corresponding to facility 300. Table SD2 includes rules derived from the automaton of FIG. 3B. At the time of system initialization, the rules expressed in one format are converted to the table illustrated in FIG. 3C using, for example, controller 60A.

Table SD2 includes columns denoted as SOURCE, DESTINATION, and DECISION. SOURCE and DESTINATION each represent a signpost identifier and DECISION represents a particular policy specific to the corresponding condition where IN/entry, OUT/exit and AT are but examples only.

Consider the first row of data which shows a rule that if the SOURCE is signpost A1 and the DESTINATION is signpost A2, then the DECISION is “in.” In the third row, the SOURCE is signpost A2 and the DESTINATION is signpost A3 and the DECISION is “AT” which denotes that the tag is at signpost A3.

FIG. 3D illustrates Table A2G which denotes groups of signposts. For example, signposts A5, A6, A7, A8, and A9 all are within a particular portion of facility 300 and thus a tag can move freely between the signposts of that group. Table A2G also shows a group including signposts A2, A3, and A4, each of which are located within a different particular portion of facility 300. Notably for this example, direct movement is not allowed between signposts A1, A10, A11, and A12. The data shown in Table A2G can also be represented as additional line entries of Table SD2. A graphical user interface can be used to represent these rules.

By default, each tag 20 begins with a starting state (location) as −1. When tag 20 appears at any signpost, it records its signpost ID and the DECISION is taken as “AT,” which means that tag 20 is at that particular location. Movement from one particular signpost to that same particular signpost is considered as “AT.”

The rules depicted in the various representations shown in FIGS. 3A, 3B, 3C, and 3D can be converted from a first format into a hash key which represents a second format. At the time of system start-up, for example, controller 60A executes a set of instructions to convert one representation of the rules into a table of hashkeys using a hash function.

A hash function is a procedure or mathematical function for converting data into a key. The value returned by a hash function is called a hash key and the hash function can be used to expedite table lookup. The hash function is used to map a search key to an index of a slot in a table where the corresponding record is stored.

A variety of hash functions can be used. One example of a hash function includes concatenation of the input data, namely, concatenation of SOURCE signpost identifier (Ax) and DESTINATION signpost identifier (Ay).

Continuing with the example using facility 300, the rules are converted to a hash table as shown below, here denoted as RULES HASH TABLE in which f(SOURCE)+f(DESTINATION)=hash key.

RULES HASH TABLE

| | |
|---|---|
| A1A2 | IN |
| A2A1 | OUT |
| A2A3 | AT |
| . | . |
| . | . |
| . | . |
| A8A9 | AT |

Each entry in the RULES HASH TABLE represents a rule that is mapped to decision when such a tag transition is detected.

In addition to the RULES HASH TABLE, system 10 also maintains a list of tags 20 that are configured for use with frame of reference 15A. The list is denoted in the following table as TAGS HASH TABLE. The entries in the list are also mapped to a recently seen signpost identifier and to a bit array corresponding to access authorizations for each zone. The length of each bit array is determined by the number of zones for the frame of reference and a logical 1 denotes an allowed zone while a logical 0 denotes a zone not allowed.

TAGS HASH TABLE

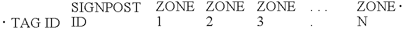

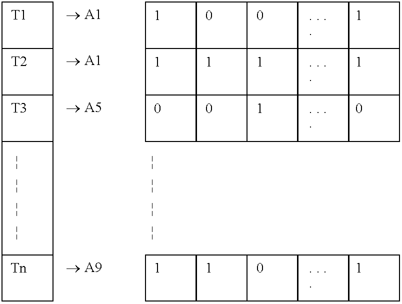

Continuing with the example for facility 300, each signpost is mapped to a particular zone. The mapping is denoted in the SIGNPOST ZONE HASH TABLE shown below. In this example, zone 1 includes signpost A1; zone 2 includes signposts A2, A3, and A4; zone 3 includes signposts A5, A6, A7, A8, and A9; and zone 4 includes signposts A10, A11, and A12.

SIGNPOST ZONE HASH TABLE

| SIGNPOST | ZONE ID |
|---|---|
| A1 | Zone 1 |
| A2 | Zone 2 |
| A3 | Zone 2 |
| . | . |
| . | . |
| . | . |
| An | Zone x |

In one example, at the time of system start-up, controller 60A executes a set of instructions to prepare and access the information denoted in the table.

The various tables and rules can be stored in memory 130 or database 75 as shown in FIG. 2.

A hash function can expedite retrieval of data. One example system can be configured to monitor a large number of readers and tags without a corresponding increase in the delay for analysis regardless of the complexity and scope of the facility layout and asset policies. This is unlike some systems in which the number of decisions to be made per unit time by a central server increases as the number of readers and tags in a system increases.

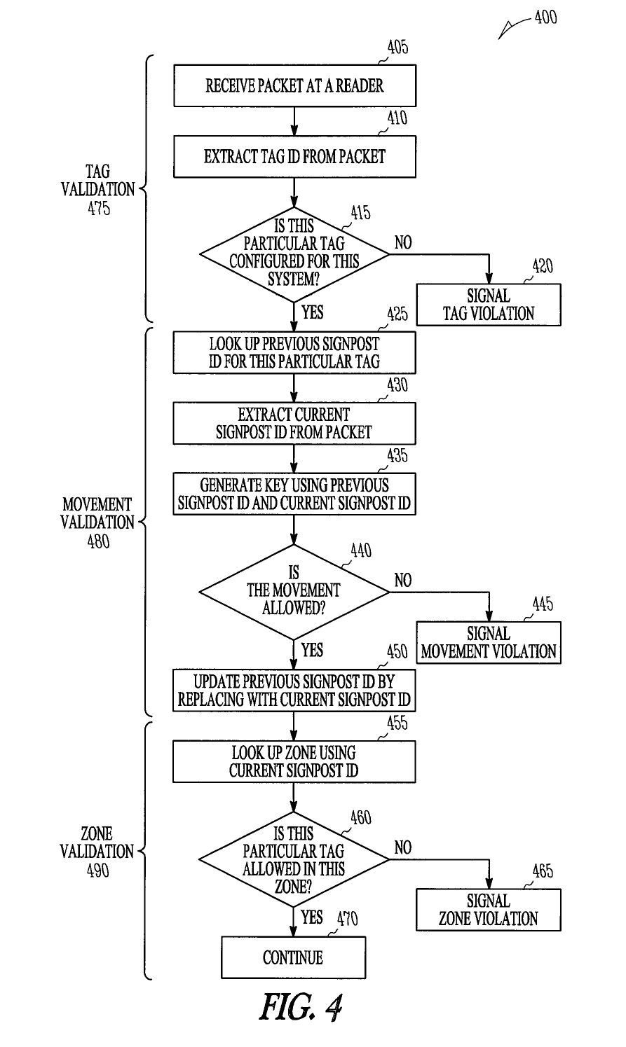

FIG. 4 illustrates a flow chart for method 400, according to one example. Method 400 includes tag validation 475, movement validation 480, and zone validation 490. Validation can be performed in a different order than illustrated and some validation routines can be added or others omitted. In one example, validation is performed by a reader (such as reader 40A), by a controller (such as controller 60A), or by computer 70.

At 405, a packet is received at a reader, such as reader 40. In one example, the contents of the packet are determined based on a signal received from a particular signpost 30 and based on a particular tag 20. As noted, tag validation can be performed at a reader level, at the controller level, or by a computer. Thus, having received the packet at the reader, the packet is forwarded to the controller (namely, the corresponding message handler for that particular reader), and (in one example) forwarded to computer 70.

At 410, the tag identification code is extracted from the packet, and at 415, a query is presented to determine if the particular tag is configured for this system. In one example, this includes accessing and searching the contents of the TAGS HASH TABLE. At 420, if the query results are in the negative, then a tag violation signal is generated. The violation signal can be sent to at least one of computer database 75, memory 130, and computer 70 (FIG. 1). If the results of the query are in the affirmative, then at 425, method 400 continues with looking up the previous signpost identification code for this particular tag. In one example, this includes accessing and searching the content of the TAGS HASH TABLE.

At 430, the current signpost identification code is extracted from the packet, and at 435, a key is generated using the previous signpost identification code and the current signpost identification code. At 440, a query is presented to determine if the particular movement or transition is allowed. This query, in one example, includes accessing the contents of the RULES HASH TABLE.

If the results of the query at 440 are in the negative, then at 445, a movement violation signal is generated. The violation signal can be sent to at least one of computer database 75, memory 130, and computer 70 (FIG. 1). If the results of the query are in the affirmative, then at 450, method 400 continues with updating the previous signpost identification code using the current signpost identification code. This updating occurs in the content of the TAGS HASH TABLE. In various examples, the updated information is also stored in database 75 or memory 130.

At 455, the current signpost identification code is used to look up a zone. This query can include accessing the contents of the SIGNPOST ZONE HASH TABLE. At 460, a query is presented to determine if the particular tag is allowed in this zone. In one example, zone violation information is accessed from TAGS HASH TABLE. If the results of the query at 460 are in the negative, then at 465, a zone violation signal is generated. The violation signal can be sent to at least one of computer database 75, memory 130, and computer 70 (FIG. 1). If the results of the query are in the affirmative, then at 470, method 400 continues continued monitoring of the tags associated with the facility.

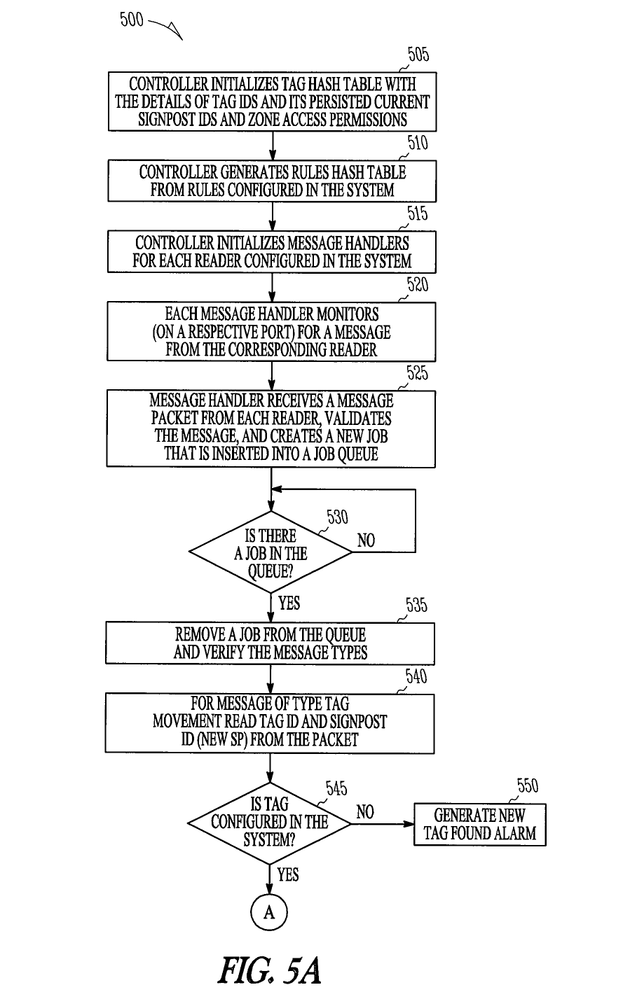

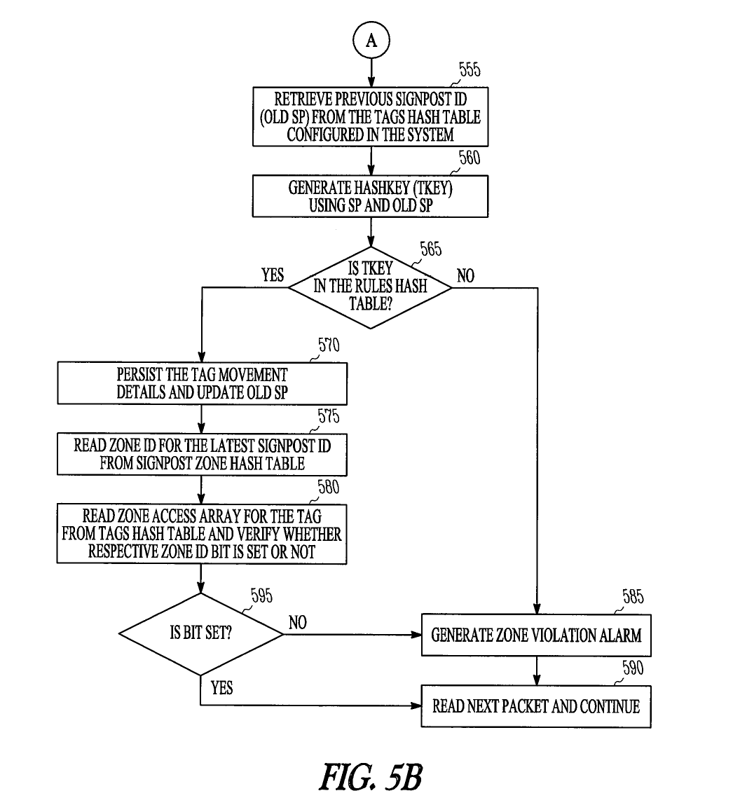

FIG. 5 illustrates a flow chart for method 500 according to one example embodiment. The various elements referenced in the following description are merely representative and other elements, including those referenced in other figures, may also be illustrative.

At 505, controller 60A initializes TAGS HASH TABLE using tag identification codes, its persisted current signpost identification codes and the zone access permission information. At 510, controller 60A generates RULES HASH TABLE from rules that are configured in system 10. The rules can represent facility policies, tag policies, tag movement authorizations and other factors. At 515, controller 60A (or controller 60B) initializes message handlers (such as message handler 105A) for each reader (such as reader 40A) configured in system 10.

At 520, each message handler (such as message handler 105A) monitors for a message from the corresponding reader (such as reader 40A). Each message handler can monitor using a specified port on the communication network 50. At 525, message handler (such as message handler 105A) receives a message packet from each reader (such as reader 40A), validates the message and creates a new job that is inserted into the job queue (such as job queue 110).

At 530, a query is presented to determine if there is a job in job queue 110. If the results of the query are in the negative, then processing loops back and continues to monitor for arrival of a job in job queue 110. If the results of the query are in the positive, then processing continues at 535, with removing the job from the queue and verifying the message type.

At 540, if the message type denotes tag movement, then method 500 includes reading the tag identification code and the new signpost identification code from the packet. At 545, a query is presented to determine if the particular tag is configured for use with the frame of reference. If the results of the query are in the negative, then a new tag found alarm signal is generated at 550. If the results of the query are in the positive, as shown by connector “A,” then processing continues at 555 (FIG. 5B), with retrieving the previous signpost identification code (old SP) using the TAGS HASH TABLE.

At 540, the message type concerns tag movement, however, this is but one example of a message type. Other types of messages can also be processed and the method can be configured to generate a signal or raise an alarm accordingly.

At 560, a hash key (TKey) is generated using the new signpost identification code and the old signpost identification code.

At 565, a query is presented to determine if the TKey is in the RULES HASH TABLE. If the results of the query are in the positive, then processing continues at 570, with updating the tag movement details and updating the old signpost identification code. At 575, the new (now current) signpost identification code, and the SIGNPOST ZONE HASH TABLE, are used to determine the zone identification code. At 580, the zone access bit array for the particular tag is checked to determine if the particular bit is set or not set.

At 595, a query is presented to determine if the bit in the zone access bit array is set. If the results of the query are in the negative, then processing continues at 585 where a zone violation alarm is generated. In addition, if the results of the query at 565 are in the negative, then, as shown at 585, method 500 includes generating a zone violation alarm. Following 585, and upon positive results of the query at 595, processing continues at 590 with reading the next packet and continuing processing.

By way of example, if message handler 105A receives (from reader 40A), a packet denoting {TagID (T2), SignPostID (A2)}, then controller 60B checks whether TagID (T2) is configured in the system. If yes, then controller 60B reads the previous signpost identification code using the TAGS HASH TABLE and calculates a hash key using the previous signpost identification code (A1) and the new signpost identification code (A2).

In this example, if the old signpost identification code is A1 and the new signpost identification code is A2, then (using a concatenation hash function) the hash key is f(A1)+f(A2)=A1A2.

Controller 60B then accesses the RULES HASH TABLE for the key A1A2. The transition is allowed if the key appears in the table; otherwise, controller 60B generates a violation alarm with respective details. System 10 then updates the current signpost identification code in the TAGS HASH TABLE and also updates the transition details in database 75.

After processing a transition rule, one example of system 10 reads the zone identification code from the SIGNPOST ZONE HASH TABLE by using the signpost identification code as a key. Controller 60B accesses the TAGS HASH TABLE to determine whether the particular tag is allowed in that zone. The TAGS HASH TABLE stores a bit array of zone privileges. If not allowed, then controller 60B generates an alarm signal. The alarm signal can be used to notify a system administrator. If, for example, signpost A1 and signpost A2 are configured in zone 1, then for the above packet, the system verifies whether the zone 1 bit (in the bit array) is set (logical value 1) or not set (logical value 0) for T2. If the bit is set, then it is allowed; otherwise controller 60B will generate a zone violation alarm.

In addition to the examples described herein concerning a facility policy, a policy concerning tag (or asset) movement, and a tag history, other parameters can also be evaluated in determining approval for a particular movement or location for an asset. For example, a fuel quantity or a battery level may be monitored with a suitable detector or sensor and used to determine if a vehicle is approved for passing through a particular gate or door. As an additional example, a rule for a particular system can specify that a particular asset can be located in a certain zone at a particular time of day but not in that same zone at another time of day. A rule can also express limits as to the number of tags that can simultaneously occupy a zone or other region. Such rules can be reflected in the hash tables described in this document.

In one example, an administrator specifies the rules for a particular tag, identifies a zone for the frame of reference, specifies reader location, and specifies a signpost location.

A system can be configured to receive a rule expressed in a graphical format and convert the graphical information into a set of rules suitable for expression in a hash table. For example, computer 70 of FIG. 1 can be programmed to present a graphical user interface to a user and by entering data using computer 70, a set of rules can be generated to describe authorized movement of a particular tag. The rules are then converted into at least one hash table as described elsewhere in this document.

The technical problem can be described as providing monitoring for a tagged asset with consideration for movement history, a facility attribute, and an asset protection policy. Current tracking system do not consider the history of tag movements in reaching a conclusion or making a decision. In addition, the amount of time takes to make decisions depends on the number of tagged objects in the facility and the number of devices installed. In a typical short range access card system (such as a smart card or passive RFID system) when a user swipes or punches the card, the system immediately concludes that the user has entered or exited. This same interpretation, when made by a long range RFID system, will produce many errors.

The technical solution to these problems includes a network of a plurality of signposts and readers, a processing engine, and a database cooperatively configured to implement a set of rules to monitor movement and a location of the tag.

One example of a system includes a controller configured for use with an asset tracking system. The controller can include a plurality of message handlers, a memory, and a processor. Each message handler is configured to receive a code from a particular reader selected from a plurality of readers. Each reader is distributed about a frame of reference. The frame of reference can include a building (such as a manufacturing plant, hospital, or a college campus), real estate (such as a parking lot or a farm), an ocean-going vessel, or other such facility. Each reader and message handler is coupled to a communication network. The network can be installed within the frame of reference or positioned in a manner that allows communication with assets that can be repositioned about the frame of reference. The message handler is configured to generate a job using the code. The code is received using a tag that is in communication with the particular reader. The memory is configured to store at least one hash table. The hash table corresponds to a rule concerning movement of the tag, concerning a policy for the frame of reference, or concerning a policy for the tag. The processor is configured to execute a set of instructions to perform the job using the hash table and the code.

One example includes a system having a communication network, a processor, and an output device. The communication network, including a plurality of readers and a plurality of signposts, corresponds to a frame of reference. The network is configured to generate a code. The code can be generated using information from a mobile tag that can be repositioned relative to the frame of reference. The processor is coupled to the communication network. The processor is configured to execute a set of instructions to evaluate the code. The processor uses at least one hash table to evaluate the code. At least one hash table corresponds to a rule associated with the frame of reference. The output device is coupled to the processor. The output device can include a light, a display, a speaker, a memory, a printer or other device.

One example includes a method. The method includes receiving information regarding a tag relative to a frame of reference. The method also includes using a processor to execute a set of instructions. The set of instructions are configured to evaluate the information using a hash table. The hash table corresponds to at least one rule and the at least one rule is configured to specify at least one of tag movement and a policy for the frame of reference. The method also includes generating a signal based on the evaluating.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown and described. However, the present inventors also contemplate examples in which only those elements shown and described are provided.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description.

Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A controller comprising:
a plurality of message handlers, each message handler configured to receive a code from a particular reader selected from a plurality of readers distributed about a frame of reference and each reader and message handler coupled to a communication network, the message handler configured to generate a job using the code, the code received using a tag in communication with the particular reader;
a memory configured to store at least one hash table, the at least one hash table corresponding to a rule concerning at least one of movement of the tag, a policy for the frame of reference, and a policy for the tag; and
a processor configured to execute a set of instructions to perform the job using the at least one hash table and the code.

2. The controller of claim 1 wherein the memory is configured to store a bit array corresponding to the rule and wherein the processor is configured to execute the set of instructions using the bit array.

3. The controller of claim 2 wherein each bit of the bit array represents access authorization for a zone corresponding to the frame of reference.

4. The controller of claim 1 wherein movement of the tag includes historical information for the tag.

5. The controller of claim 1 wherein the processor is configured to convert the rule from one format into the hash table.

6. The controller of claim 1 wherein the processor is configured to generate an output signal based on performance of the job.

7. The controller of claim 1 wherein at least one of a particular message handler, the particular reader, the processor, and a computer in communication with the processor is configured to evaluate validity of the received code.

8. The controller of claim 1 wherein the memory is configured to store a list of identifiers for each of a plurality of tags.

9. A system comprising:
a communication network corresponding to a frame of reference, the network configured to generate a code using a mobile tag relative to the frame of reference;
a processor coupled to the communication network and configured to execute a set of instructions to evaluate the code using at least one hash table, the at least one hash table corresponding to a rule associated with the frame of reference; and
an output device coupled to the processor.

10. The system of claim 9 wherein a particular hash table of the at least one hash table represents at least one of movement of the tag relative to the frame of reference, a policy associated with the frame of reference, and a structure corresponding to the frame of reference.

11. The system of claim 9 wherein the communication network includes a plurality of readers disposed about the frame of reference, at least one reader configured to receive a message from the tag and generate the code.

12. The system of claim 11 wherein the communication network includes a plurality of signposts disposed about the frame of reference, at least one signpost configured to transmit an identifier, and further wherein the tag is configured to generate the message using the identifier.

13. The system of claim 9 further including a memory coupled to the processor, the memory configured to store the at least one hash table.

14. The system of claim 9 wherein the output device includes at least one of a light, a display, a speaker, a memory, and a printer.

15. A machine implemented method comprising:
receiving information corresponding to a mobile tag;
evaluating the received information using a hash table, the hash table corresponding to at least one rule and the at least one rule configured to specify at least one of tag movement and a policy for a frame of reference associated with the tag; and
generating a signal based on the evaluating.

16. The method of claim 15 wherein receiving information includes receiving information using a digital data network.

17. The method of claim 15 wherein receiving information includes receiving a signpost code, the signpost code corresponding to a zone relative to the frame of reference.

18. The method of claim 15 further including:
receiving the at least one rule in a first format; and
converting the at least one rule in the first format to the hash table.

19. The method of claim 15 wherein the rule includes historical data for the tag.

20. The method of claim 15 wherein the rule includes at least one of a restriction on permissible movement of the tag and a restriction based on the frame of reference.

21. The method of claim 15 wherein generating the signal includes generating a violation signal.
